(19) United States
(12) Patent Application Publication
(10) Pub. No.: US 2015/0319550 A1
(43) Pub. Date: Nov. 5, 2015

(54) COMMUNICATION METHOD, SOUND APPARATUS AND COMMUNICATION APPARATUS

(71) Applicant: YAMAHA CORPORATION, Hamamatsu-shi, Shizuoka (JP)

(72) Inventor: Hiroyuki FUJITA, Hamamatsu-shi (JP)

(73) Assignee: YAMAHA CORPORATION, Hamamatsu-shi, Shizuoka (JP)

(21) Appl. No.: 14/650,454

(22) PCT Filed: Dec. 3, 2013
(86) PCT No.: PCT/JP2013/082443

§ 371 Date: Jun. 8, 2015

(30) Foreign Application Priority Data
Dec. 28, 2012 (JP) 2012-287209

(51) Int. Cl. H04S 7/00; H04S 1/00

(52) U.S. Cl. CPC H04S 7/302; H04S 1/00

(57) ABSTRACT

A sound apparatus includes: an acquisition unit that acquires multichannel audio data; a transmission unit that transmits the multichannel audio data to a conversion apparatus via a communication network; a reception unit that receives from the conversion apparatus, two-channel audio data generated by converting the multichannel audio data into a virtual sound source by the conversion apparatus; and an audio reproduction unit that drives two loudspeakers according to the two-channel audio data.

### TECHNICAL FIELD

The present invention relates to a technology that reproduces multichannel sound by using two loudspeakers.

Priority is claimed on Japanese Patent Application No. 2012-287209 filed Dec. 28, 2012, the content of which is incorporated herein by reference.

### BACKGROUND ART

As an example of this kind of technology, a technology disclosed in Patent Document 1 can be mentioned. In the technology disclosed in Patent Document 1, a process described below is performed by an audio amplifier connected with respective loudspeakers of a left front channel and a right front channel. According to the process, reproduction of multichannel sound including left and right rear channels or the like in addition to the left front channel and the right front channel can be realized. That is to say, when a multichannel audio signal is provided, the audio amplifier disclosed in Patent Document 1 performs filter processing with respect to an audio signal of the rear channel so that a virtual audio image of the rear channel is localized at a loudspeaker position of the rear channel. The audio amplifier superimposes the audio signal having been subjected to the filter processing, on the audio signals of the left front channel and the right front channel and outputs it. A filter coefficient in the filter processing is a coefficient obtained by simulating a transmission characteristic (head-related transfer function) from the loudspeaker position of the rear channel up to the ears of a listener based on the head shape of the listener. The above audio amplifier includes a head shape detection means that detects the head shape of the listener, and a filter coefficient supply means that calculates the above filter coefficient according to the head shape detected by the head shape detection means and supplies it to a filter that performs the above filter processing.

### PRIOR ART DOCUMENT

### Patent Document

[Patent Document 1] Japanese Unexamined Patent Application, First Publication No. 2003-230199

### SUMMARY OF THE INVENTION

### Problem to be Solved by the Invention

For calculation of the head-related transfer function according to the head shape of the listener, a CPU (Central Processing Unit) or a DSP (Digital Signal Processor) having high processing capacity is required. However, when a CPU or a DSP having high processing capacity is provided in the audio amplifier, the cost of the audio amplifier becomes very high.

The present invention has been achieved in view of the above situation. One example of an object of the present invention is to provide a technology that enables reproduction of multichannel audio data without providing a CPU or a DSP having high processing capacity, in a sound apparatus connected to two loudspeakers.

### Means for Solving the Problem

A sound apparatus according to an aspect of the present invention includes: an acquisition unit that acquires multichannel audio data; a transmission unit that transmits the multichannel audio data to a conversion apparatus via a communication network; a reception unit that receives from the conversion apparatus, two-channel audio data generated by converting the multichannel audio data into a virtual sound source by the conversion apparatus; and an audio reproduction unit that drives two loudspeakers according to the two-channel audio data.

In the above sound apparatus, the conversion apparatus connected to the sound apparatus via the communication network converts sound of the multichannel audio data (for example, respective left and right surround channels or respective left and right rear channels) into a virtual sound source (the conversion apparatus may be a cloud server that provides a cloud service for converting the rear channel audio data into the virtual sound source with respect to the sound apparatus). Consequently, it is possible to reproduce the multichannel sound by using the two loudspeakers, without the sound apparatus including a CPU or a DSP having high processing capacity.

A communication method according to an aspect of the present invention is used for a communication system including: a sound apparatus connected with two loudspeakers and connected to a communication network; and a conversion apparatus connected to the communication network. The communication method includes: acquiring multichannel audio data including pieces of audio data of a left front channel, a right front channel, and a first channel; transmitting the multichannel audio data from the sound apparatus to the conversion apparatus via the communication network; converting audio data of at least the first channel of the multichannel audio data into a virtual sound source by using a head-related transfer function; superimposing the converted audio data of at least the first channel on the left front channel and the right front channel to generate two-channel audio data; transmitting the two-channel audio data from the conversion apparatus to the sound apparatus via the communication network; and driving the two loudspeakers according to the two-channel audio data.

A communication apparatus according to an aspect of the present invention includes: an acquisition unit that acquires multichannel audio data; a transmission unit that transmits the multichannel audio data to a conversion apparatus via a communication network; a reception unit that receives from the conversion apparatus via the communication network, two-channel audio data generated by converting the multichannel audio data into a virtual sound source by the conversion apparatus; and an output unit that outputs the two-channel audio data to a sound apparatus.

### BRIEF DESCRIPTION OF THE DRAWINGS

FIG. 1 is a diagram showing a configuration example of a communication system according to a first embodiment of the present invention.

FIG. 2 is a diagram showing an arrangement example of a display apparatus, a camera, and two loudspeakers in the first embodiment.

FIG. 3 is a diagram showing a loudspeaker arrangement example in 7.1-channel multi-surround.

FIG. 4 is an explanatory diagram of an operation of a virtual sound source acquisition apparatus in the communication system shown in FIG. 1.

FIG. 5A is an explanatory diagram of an operation of a virtual sound source acquisition apparatus of a second embodiment of the present invention.

FIG. 5B is an explanatory diagram of the operation of the virtual sound source acquisition apparatus of the second embodiment of the present invention.

FIG. 6 is a diagram showing a communication system of a second modified example of the first and second embodiments.

FIG. 7 is a diagram showing a communication system according to a third modified example of the first and second embodiments.

FIG. 8 is a diagram showing a communication system according to a fourth modified example of the first and second embodiments.

FIG. 9 is a diagram showing a configuration example of a communication system of a fifth modified example according to the first and second embodiments.

### EMBODIMENTS FOR CARRYING OUT THE INVENTION

Hereunder, embodiments of the present invention will be described with reference to the drawings.

### First Embodiment

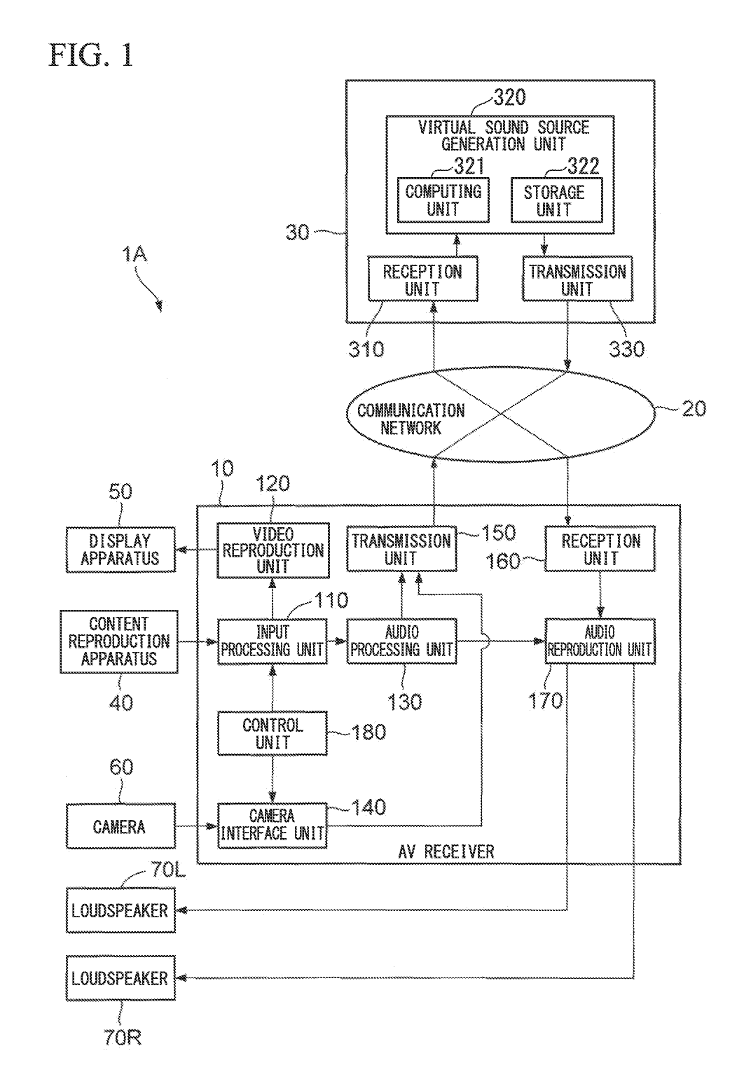

FIG. 1 is a diagram showing a configuration example of a communication system 1A according to a first embodiment of the present invention.

The communication system 1A includes an AV receiver 10 and a virtual sound source acquisition apparatus 30. The AV receiver 10 may be a specific example of a sound apparatus. Hereunder, the virtual sound source acquisition apparatus 30 is simply referred to as conversion apparatus 30. As shown in FIG. 1, the AV receiver 10 and the virtual sound source acquisition apparatus 30 are connected to a communication network 20 being an electric communication line such as the Internet. A communication address for uniquely identifying respective devices such as an IP (Internet Protocol) address or a MAC (Media Access Control) address is assigned beforehand to the AV receiver 10 and the conversion apparatus 30. The AV receiver 10 and the conversion apparatus 30 perform data communication according to a predetermined communication protocol via the communication network 20.

For example, when data is transmitted from the AV receiver 10 to the conversion apparatus 30, the AV receiver 10 divides data to be transmitted into data blocks having a preset data size, and adds a predetermined header to each data block. Moreover, the AV receiver 10 sends the respective data blocks to the communication network 20 sequentially in order from the first data block. The header includes information indicating what number the data block is from the first of the data to be transmitted. Furthermore, the header includes a communication address of the AV receiver 10 as an identifier indicating a transmission source, and a communication address of the conversion apparatus 30 as an identifier indicating a destination. Thus, the respective data blocks transmitted from the AV receiver 10 reach the destination via routing by relay apparatuses (for example, a router or a switching hub) provided in the communication network 20. The conversion apparatus 30 being the destination of the respective data blocks, refers to the header added to the received data block to connect the respective data blocks, and restores the data to be transmitted.

As shown in FIG. 1, a content reproduction apparatus 40, a display apparatus 50, a camera 60, and loudspeakers 70L and 70R are connected to the AV receiver 10. The content reproduction apparatus 40 may be, for example, a DVD (Digital Versatile Disc) player or a Blu-ray disc player. Upon reception of a reproduction start instruction from the AV receiver 10, the content reproduction apparatus 40 starts to read contents data recorded in a recording medium such as a DVD or a Blu-ray disc, and provides the read contents data to the AV receiver 10. The contents data includes video data representing video constituting the contents, and audio data representing audio to be reproduced synchronized with video display. The display apparatus 50 may be, for example, a liquid crystal display. The display apparatus 50 displays the video corresponding to a video signal provided from the AV receiver 10. The camera 60 may be a digital camera using, for example, a CCD (Charge Coupled Device) image sensor. The camera 60 captures an image in response to an imaging instruction provided from the AV receiver 10, and provides image data representing the captured image to the AV receiver 10. The respective loudspeakers 70L and 70R output analog audio signals provided from the AV receiver 10 as sound.

The AV receiver 10 and the respective apparatus (in the present embodiment, the content reproduction apparatus 40, the display apparatus 50, the camera 60, and the loudspeakers 70L and 70R) connected to the AV receiver 10 may be arranged in a living room of a user who views the contents by using the AV receiver 10. In the explanation below, a set of the AV receiver 10 and the respective apparatus (in the present embodiment, the content reproduction apparatus 40, the display apparatus 50, the camera 60, and the loudspeakers 70L and 70R) connected to the AV receiver 10 may be referred to as “client side apparatus group”. In FIG. 1, one set of client side apparatus groups is shown. However, the number of the client side apparatus groups is not limited to one. The communication system 1A may include a plurality of client side apparatus groups.

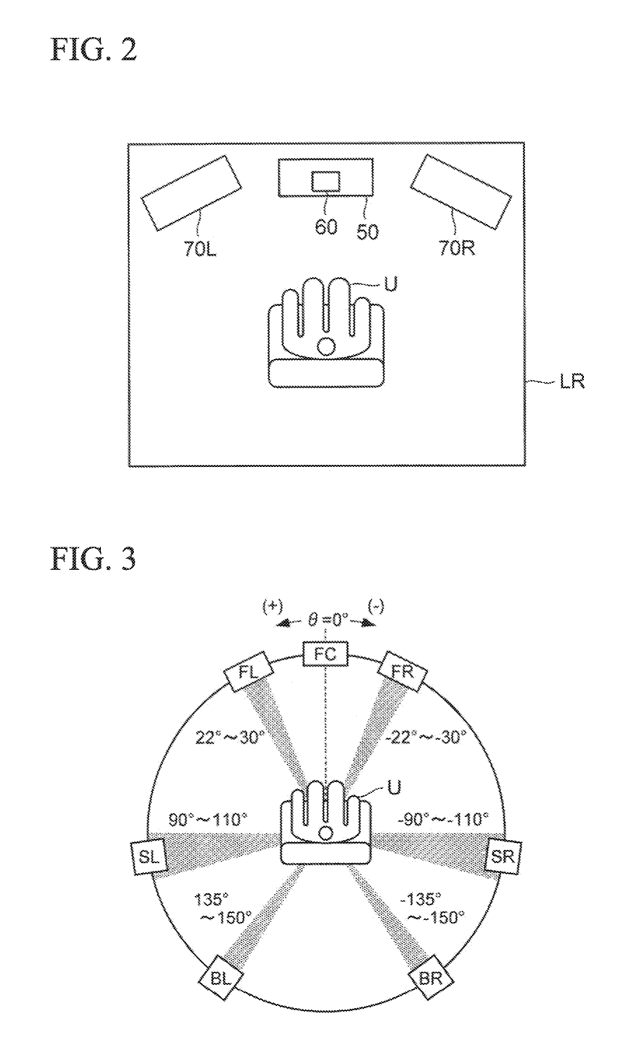

FIG. 2 is a diagram showing an arrangement example of the display apparatus 50, the camera 60, and the loudspeakers 70L and 70R included in one set of client side apparatus groups in a living room LR. As shown in FIG. 2, the display apparatus 50 is arranged on a front side of a user U who seats at a viewing position (that is, a viewer of the contents reproduced by the AV receiver 10). The loudspeaker 70L is arranged on the front left side of the user U. The loudspeaker 70R is arranged on the front right side of the user U. That is to say, the loudspeaker 70L functions as a left front channel loudspeaker that outputs sound arriving from the left front side of the user U who seats at the viewing position. The loudspeaker 70R functions as a right front channel loudspeaker that outputs sound arriving from the right front side of the user U. The camera 60 is arranged on the display apparatus 50 in a state with an imaging surface facing the viewing position. The reason why the camera 60 is arranged in this manner is for capturing an image of the head of the user U who seats at the viewing position to view the contents.

The AV receiver 10 has an audio amplifier function of receiving the contents data from the content reproduction apparatus 40 and controlling actuation of the loudspeakers 70L and 70R and the display apparatus 50. Moreover, the AV receiver 10 has a communication function of performing data communication via the communication network 20. The AV receiver 10 also has a tuner function as in a general AV receiver. Because the tuner function does not have a direct relation with the present embodiment, the explanation of the tuner function is omitted. As shown in FIG. 1, the AV receiver 10 includes an input processing unit 110, a video reproduction unit 120, an audio processing unit 130, a camera interface unit 140, a transmission unit 150, a reception unit 160, an audio reproduction unit 170, and a control unit 180 that controls actuation of these respective units. The input processing unit 110 and the reception unit 160 may be a specific example of the acquisition unit. The reception unit 160 may be a specific example of the output unit.

The input processing unit 110 may be, for example, an HDMI (registered trademark) (High-Definition Multimedia Interface). The input processing unit 110 is connected to the content reproduction apparatus 40 via a signal line such as an HDMI cable. The input processing unit 110 provides a reproduction start instruction to the content reproduction apparatus 40 and receives the contents data transmitted from the content reproduction apparatus 40 under control of the control unit 180. The input processing unit 110 separates the video data and the audio data from the received contents data. The input processing unit 110 provides the video data to the video reproduction unit 120 and provides the audio data to the audio processing unit 130.

The video reproduction unit 120 is connected to the display apparatus 50. The video reproduction unit 120 generates a video signal based on the video data provided from the input processing unit 110, and provides the video signal to the display apparatus 50. The audio processing unit 130 analyzes the audio data provided from the input processing unit 110 to discriminate whether the audio data is one-channel audio data on each of the left and right sides (that is, two-channel audio data) or multichannel audio data. When having determined that the audio data provided from the input processing unit 110 is the two-channel audio data, the audio processing unit 130 provides the audio data to the audio reproduction unit 170. When having determined that the audio data is the multichannel audio data, the audio processing unit 130 provides the audio data to the transmission unit 150.

The camera interface unit 140 is connected to the camera 60. The camera interface unit 140 provides the imaging instruction to the camera 60, and provides the image data provided from the camera 60 to the transmission unit 150 under control of the control unit 180.

The transmission unit 150 and the reception unit 160 may be, for example, an NIC (Network Interface Card). The transmission unit 150 and the reception unit 160 are connected to the communication network 20. The transmission unit 150 transmits the multichannel audio data provided from the audio processing unit 130 and the image data provided from the camera interface unit 140 to the conversion apparatus 30 according to the predetermined communication protocol. The conversion apparatus 30 receives the multichannel audio data transmitted from the AV receiver 10 in this manner. The conversion apparatus 30 converts rear channel sound expressed by the received multichannel audio data into a virtual sound source, performs a process of superimposing the virtual sound source on respective left and right front channels and converts to the two-channel audio data, and returns it to the AV receiver 10. The details thereof will be described later. The image data transmitted from the AV receiver 10 to the conversion apparatus 30 is used for calculation of a head-related transfer function to be used at the time of converting sound into the virtual sound source. The reception unit 160 receives the two-channel audio data returned from the conversion apparatus 30, and provides it to the audio reproduction unit 170.

The audio reproduction unit 170 is connected to the loudspeaker 70L and the loudspeaker 70R. The audio reproduction unit 170 D/A converts the two-channel audio data provided from the audio processing unit 130 or the two-channel audio data provided from the reception unit 160, to generate respective analog audio signals of the left channel and the right channel. The audio reproduction unit 170 provides the generated analog audio signals to the respective loudspeakers 70L and 70R.

The configuration of the client side apparatus group is as described above.

A configuration of the conversion apparatus 30 will be described next.

As shown in FIG. 1, the conversion apparatus 30 includes a reception unit 310, a virtual sound source generation unit 320, and a transmission unit 330. Hereunder, the virtual sound source generation unit 320 is simply referred to as generation unit 320. The reception unit 310 and the transmission unit 330 may be, for example, an NIC. The reception unit 310 and the transmission unit 330 are connected to the communication network 20. The reception unit 310 receives data transmitted via the communication network 20 according to the predetermined communication protocol, and provides the data to the generation unit 320. In the present embodiment, the transmitted data is the image data or the multichannel audio data transmitted from the AV receiver 10. The transmission unit 330 sends the data provided from the generation unit 320 to the communication network 20 according to the predetermined communication protocol.

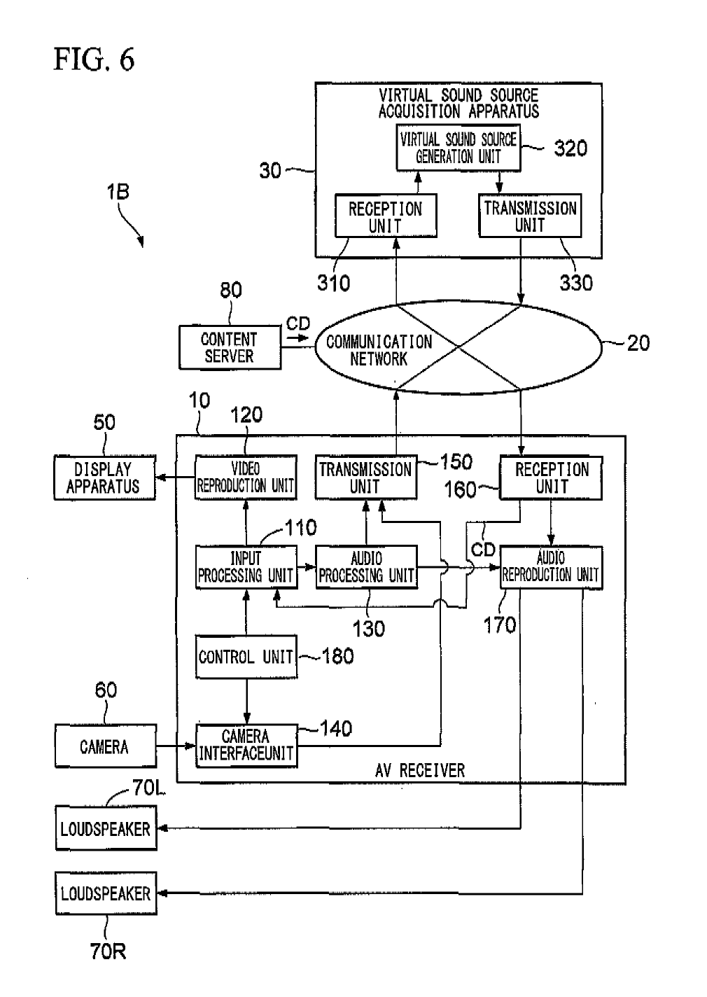

The generation unit 320 includes a computing unit 321 such as a CPU or a DSP, and a storage unit 322 such as a RAM (Random Access Memory) (in FIGS. 6 to 9, only the generation unit 320 is shown, and illustration of the computing unit 321 and the storage unit 322 is omitted).

A case in which the image data is provided to the generation unit 320 from the reception unit 310 will be described. In this case, the computing unit 321 (that is, the generation unit 320, and similarly hereunder) generates head shape data indicating a head shape (for example, a face width and the size of an auricle) of the user U captured in the image expressed by the image data. Moreover, the virtual sound computing unit 321 writes the head shape data into the storage unit 322 in association with an identifier indicating a transmission source of the image data.

A case in which the multichannel audio data is provided to the generation unit 320 from the reception unit 310 will be described. In this case, the computing unit 321 converts the multichannel audio data into the two-channel audio data. More specifically, the computing unit 321 converts sounds of respective left and right channels other than the left front channel and the right front channel into the virtual sound source by using arrival directions of the sounds and the head-related transfer function corresponding to the head shape of a listener of the sounds (in the present embodiment, the user U). The computing unit 321 performs a process of superimposing the sounds of the respective channels converted into the virtual sound source, on the left front channel and the right front channel to generate the two-channel audio data. The computing unit 321 provides the two-channel audio data to the transmission unit 330. As a specific method of detecting the head shape of the listener from the image data capturing the head of the listener, a specific calculation method of the head-related transfer function, and a specific method of converting into the virtual sound source by using the head-related transfer function, a method disclosed in U.S. Pat. No. 7,095,865 may be used. The present application incorporates the contents of U.S. Pat. No. 7,095,865 herein by reference.

The configuration of the communication system 1A according to the present embodiment is as described above.

Operations of the AV receiver 10 and the conversion apparatus 30 when 7.1-channel audio data is provided from the content reproduction apparatus 40 to the AV receiver 10 will be described next as a specific example. The 7.1-channel audio data includes pieces of audio data of the respective channels of a left front channel FL, a right front channel FR, a center channel FC, a left surround side channel SL, a right surround side channel SR, a left surround back channel BL, a right surround back channel BR, and a subwoofer channel LFE. The center channel FC represents sound arriving from the front of the user U seated at the viewing position. The left surround side channel SL represents sound arriving from the left side of the user U. The right surround side channel SR represents sound arriving from the right side of the user U. The left surround back channel BL represents sound arriving from the left rear side of the user U. The right surround back channel BR represents sound arriving from the right rear side of the user U. The subwoofer channel LFE represents ultra-low pitched sound. When sounds of seven channels excluding the subwoofer channel LFE are reproduced by actual loudspeakers, then as shown in FIG. 3, it is recommended by the ITU recommendation to arrange the respective loudspeakers on a circumference with the listener as a center. In contrast to this, the AV receiver 10 according to the present embodiment is connected only to two actual loudspeakers, that is, the loudspeaker 70L that functions as a loudspeaker of the left front channel FL and the loudspeaker 70R that functions as a loudspeaker of the right front channel FR. Therefore, in the present embodiment, the sounds of respective channels of the center channel FC, the left surround side channel SL, the right surround side channel SR, the left surround back channel BL, the right surround back channel BR, and the subwoofer channel LFE are converted into the virtual sound source.

The user U seats at a preset viewing position (see FIG. 2) in order to view the contents by using the AV receiver 10, and instructs viewing start of the contents to the AV receiver 10 by using a remote control or the like. Thus, upon instruction of viewing start, the control unit 180 of the AV receiver 10 causes the camera interface unit 140 to output an imaging instruction, and causes the input processing unit 110 to output a reproduction start instruction. The camera 60 performs imaging in response to the imaging instruction to acquire image data, and outputs the image data to the AV receiver 10. As described above, the camera 60 is installed on the display apparatus 50 with the imaging surface facing the viewing position. Consequently, the image represented by the image data includes an image of the head of the user U seating at the viewing position. The image data provided from the camera 60 to the AV receiver 10 is transmitted to the conversion apparatus 30 via the communication network 20 by the operation of the camera interface unit 140 and the transmission unit 150 of the AV receiver 10. Upon reception of the image data via the reception unit 310, the computing unit 321 in the generation unit 320 of the conversion apparatus 30 analyzes the image data to generate the head shape data. Moreover, the computing unit 321 writes the head shape data into the storage unit 322 in association with an identifier indicating the transmission source of the image data.

The content reproduction apparatus 40 reads the contents data from a recording medium in response to the reproduction start instruction provided from the AV receiver 10, and provides the contents data to the AV receiver 10. Upon reception of the contents data from the content reproduction apparatus 40, the input processing unit 110 of the AV receiver 10 separates the audio data and the video data included in the contents data. The input processing unit 110 provides the audio data to the audio processing unit 130, and provides the video data to the video reproduction unit 120. As described above, in the present operation example, the audio data included in the contents data to be provided from the content reproduction apparatus 40 to the AV receiver 10 is the 7.1-channel audio data. Consequently, the audio processing unit 130 provides the audio data provided from the input processing unit 110 to the transmission unit 150. The transmission unit 150 also transmits the audio data to the conversion apparatus 30.

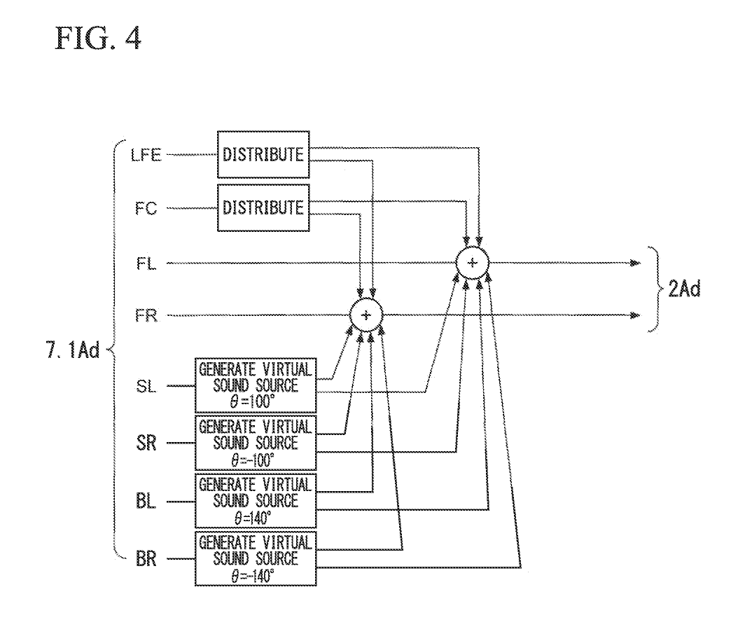

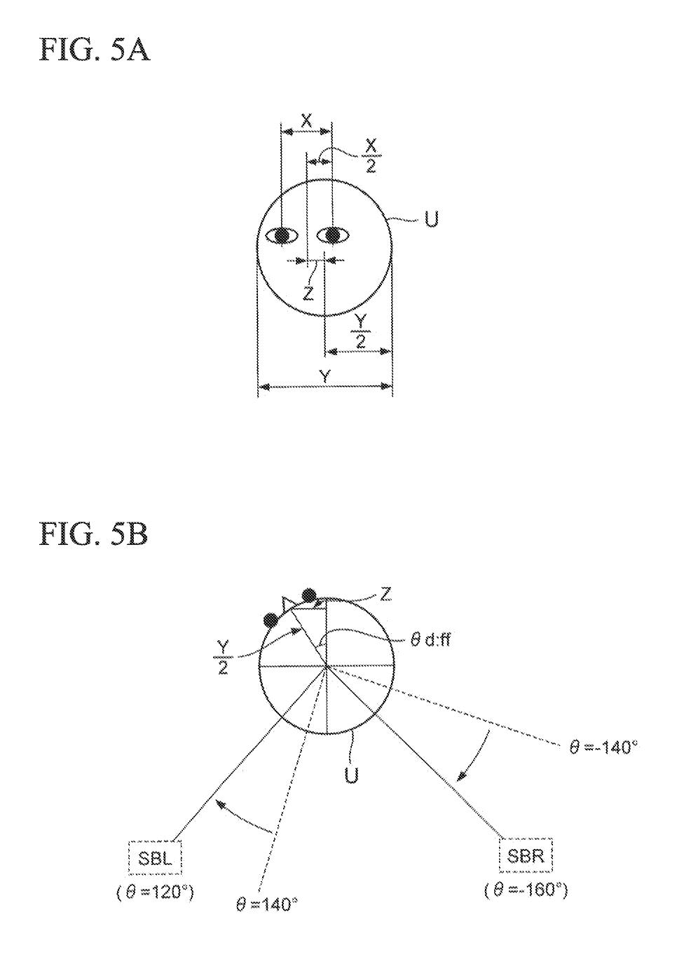

The multichannel audio data transmitted from the AV receiver 10 to the conversion apparatus 30 via the communication network 20 is received by the reception unit 310 of the conversion apparatus 30. The reception unit 310 provides the received multichannel audio data to the generation unit 320. FIG. 4 shows an example of a process performed by the generation unit 320 with respect to the multichannel audio data delivered from the reception unit 310 in the conversion apparatus 30. As shown in FIG. 4, the generation unit 320 converts the 7.1 channel audio data (shown as 7.1Ad in FIG. 4) into the two-channel audio data (shown as 2Ad in FIG. 4). More specifically, the generation unit 320 evenly distributes the respective pieces of audio data of the subwoofer channel LFE and the center channel FC of the 7.1-channel audio data, and superimposes them on the respective pieces of audio data of the left front channel FL and the right front channel FR. On the other hand, the generation unit 320 performs a process of converting each of the left surround side channel SL, the right surround side channel SR, the left surround back channel BL, and the right surround back channel BR (that is, the left and right channels other than the left front channel and the right front channel) into the virtual sound source, and then superimposes them on the respective pieces of audio data of the left front channel FL and the right front channel FR.

More specifically, in the process of converting each of the left surround side channel SL, the right surround side channel SR, the left surround back channel BL, and the right surround back channel BR into the virtual sound source, the computing unit 321 first calculates the head-related transfer function for each channel based on the head shape data stored in the storage unit 322 in association with the identifier indicating the transmission source of the multichannel audio data and an angle θ indicating the arrival direction of the sound to the listener (that is, an angle corresponding to the channel). For example, the head-related transfer function of the respective channels may be calculated by assuming that θ=100° for the left surround side channel SL, θ=−100° for the right surround side channel SR, θ=140° for the left surround back channel BL, and θ=−140° for the right surround back channel BR. The computing unit 321 writes the head-related transfer function data representing the calculated head-related transfer function into the storage unit 322 in association with the identifier and information indicating the channel (for example, information indicating the angle θ).

Subsequently, the computing unit 321 performs the filter processing of convolving the calculated head-related transfer function with respect to the respective pieces of audio data of the left surround side channel SL, the right surround side channel SR, the left surround back channel BL, and the right surround back channel BR. The computing unit 321 distributes the filter-processed respective pieces of audio data to a left front component and a right front component, and performs adjustment of a delay amount of the respective components, crosstalk cancellation, and the like. Next, the computing unit 321 superimposes the respective pieces of audio data having been subjected to various processes on the respective pieces of audio data of the left front channel FL and the right front channel FR and outputs the superimposed audio data. When the subsequent multichannel audio data is received from the same transmission source, the computing unit 321 may convert the audio data of the respective channels into the virtual sound source by using the head-related transfer function data stored in the storage unit 321 in association with the identifier indicating the transmission source.

As described above, the two-channel audio data output from the generation unit 320 is returned to the transmission source of the multichannel audio data (the AV receiver 10 in the present operation example) by the transmission unit 330. Upon reception of the two-channel audio data returned from the conversion apparatus 30, the reception unit 160 of the AV receiver 10 provides the two-channel audio data to the audio reproduction unit 170. The audio reproduction unit 170 provides an audio signal of the left front channel FL generated according to the audio data to the loudspeaker 70L. Moreover, the audio reproduction unit 170 provides the audio signal of the right front channel FR generated according to the audio data to the loudspeaker 70R. The user U of the AV receiver 10 listens to the sound output from the loudspeakers 70L and 70R in this manner. As a result, an auditory sensation as if the sounds of the left surround side channel SL, the right surround side channel SR, the left surround back channel BL, and the right surround back channel BR arrive from behind the user is provided to the user U, and an auditory sensation as if the sounds of the center channel FC and the subwoofer channel LFE arrive from the center position of the loudspeakers 70L and 70R is provided to the user U.

As described above, in the first embodiment, the conversion apparatus 30 is caused to convert the multichannel audio data into the two-channel audio data. As a result, a CPU or a DSP having high processing capacity need not be provided in the AV receiver 10. That is to say, according to the first embodiment, multichannel sound can be reproduced by using the left and right one-channel loudspeakers without providing a CPU or a DSP having high processing capacity in the AV receiver 10. Moreover, if a conversion apparatus 30 having sufficiently high processing capacity is used, even when the conversion service is provided to the plurality of sets of client side apparatus groups, real-time reproduction of the contents can be performed without any problem.

### Second Embodiment

In the first embodiment, the conversion apparatus 30 connected to the communication network 20 is caused to execute the conversion process from the multichannel audio data to the two-channel audio data. As a result, in the first embodiment, multichannel sound can be reproduced by using the left and right one-channel loudspeakers without providing a CPU or a DSP having high processing capacity in the AV receiver 10. The second embodiment is different from the first embodiment in that image data provided from a reception unit 310 is analyzed to detect the direction of the face of a user U, and an arrival direction of sound to be converted into the virtual sound source is corrected according to the direction of the face of the user U, thereby calculating a head-related transfer function. Hereunder, a method of detecting the direction of the face of the user U based on an image captured by a camera 60 will be described.

A generation unit 320 of the second embodiment analyzes the image data received from the reception unit 310 to recognize the face of the user U included in the image represented by the image data. A technology disclosed in U.S. Pat. No. 7,095,865 can be used as a technology for recognizing the face. FIG. 5A is a schematic diagram of the face of the user U recognized by the generation unit 320. The generation unit 320 specifies the position of eyes in the face recognized by using the face recognition technology described above to specify a central position between both eyes. More specifically, the generation unit 320 obtains a gap X between both eyes (see FIG. 5A), and specifies a position of X/2 from a position of one eye toward the other eye as the central position between both eyes.

Moreover, the generation unit 320 obtains a width Y of the face of the user U (see FIG. 5A) by the method disclosed in U.S. Pat. No. 7,095,865, and specifies a position away by Y/2 from one end of the face toward the other end as the central position of the face of the user U. The generation unit 320 obtains a difference Z between the central position between both eyes of the user U and the central position of the face of the user U. The generation unit 320 obtains an angle θdiff representing the direction of the face of the user U according to the following equation (1). In the case of a state in which the user U faces the front, that is, the central position between both eyes of the user U matches with the central position of the face, then θdiff=0°. sin⁻¹( ) on the right side of the equation (1) stands for an arcsine function. The reason why the angle θdiff representing the direction of the face of the user U can be calculated by the equation (1) is evident from the geometric relationship shown in FIG. 5B.

θdiff=sin⁻¹(2Z/Y) (1)

Next, the generation unit 320 corrects the angle θ representing the direction of a localization position of the virtual sound source according to the angle θdiff. The generation unit 320 calculates the head-related transfer function with taking into account the corrected angle θ and the head shape of the user U. A case of calculating the head-related transfer function designating the angle θ as θdiff=20° will be described as a specific example. In this case, the angle θ indicating the arrival direction of the left surround back channel BL is corrected to 120° (=140°−20°), and the angle θ indicating the arrival direction of the right surround back channel BR is corrected to −160° (=−140°−20° to calculate the head-related transfer function.

The reason why the head-related transfer function is calculated in this way with taking into account the direction of the face of the viewer in addition to the head shape of the viewer of the contents is as described below. If it is converted into the virtual sound source of the rear channel by using the head-related transfer function obtained by assuming that the viewer faces the front in a state with the direction of the face of the viewer deviating from the front, the localization position of the virtual sound source deviates relatively by the deviation of the direction of the face of the viewer. In the contents such as a movie, the arrival directions of sounds of the respective channels are often set by taking dramatic impact into consideration, assuming that the viewer faces the front. As a result, if the localization position of the virtual sound source deviates relatively due to the deviation of the direction of the face of the viewer, dramatic impact intended by a content producer may become impaired. In contrast, according to the second embodiment, because the head-related transfer function is calculated with taking into account the direction of the face of the viewer to correct the localization position of the virtual sound source, then even if the direction of the face of the viewer deviates from the front, the dramatic impact intended by the content producer or the like does not become impaired. This is the reason why the head-related transfer function is calculated with taking into account the direction of the face of the viewer in addition to the shape of the head of the viewer.

In this way, according to the second embodiment, by taking into account the direction of the face of the viewer, conversion of the rear channel sound into the virtual sound source can be performed more sensitively, and multichannel sound may be reproduced by using the left and right one-channel loudspeakers.

Also in the second embodiment, the conversion apparatus 30 performs the process of converting the rear channel sound into the virtual sound source. Consequently, also in the second embodiment, a CPU or a DSP having high processing capacity need not be provided in the AV receiver 10.

The AV receiver 10 may transmit the image data to the conversion apparatus 30 every time a predetermined time has passed. The AV receiver 10 determines whether the present image data acquired by the camera 60 is different from the previous image data. When it is determined that both pieces of image data are different from each other, the AV receiver 10 may transmit the acquired image data to the conversion apparatus 30 (for example, the AV receiver 10 determines whether the shape of the user's head represented by the present image data is different from the shape of the user's head represented by the previous image data). A computing unit 321 may calculate the head-related transfer function every time the image data is received, and write the head-related transfer function into a storage unit 322. When the process is performed in this manner, if the user viewing the contents performs a motion such as changing the direction of the face, the localization position of the virtual sound source can be updated, following the motion. That is to say, when performing such a process, even if the user changes the direction of the face during reproduction of the sound by the AV receiver 10, the head-related transfer function following the motion can be used. As a result, the localization position of the virtual sound source can be changed, following the motion of the user.

### Modified Examples

The first and second embodiments of the present invention have been described above. These embodiments may be modified as described below.

### First Modified Example

In the first and second embodiments, the contents data provided to the AV receiver 10 includes the audio data and the video data. However, the configuration is not limited thereto. The contents data may include only the audio data. In this case, the input processing unit 110 and the video reproduction unit 120 may be omitted.

### Second Modified Example

In the first and second embodiments, the supply source of the contents data with respect to the AV receiver 10 is the content reproduction apparatus 40 connected to the AV receiver 10 via the signal line such as the HDMI cable. However, the configuration is not limited thereto. FIG. 6 shows a communication system 1B according to a second modified example. The communication system 1B includes at least a content server 80 that distributes contents data CD. The content server 80 is connected to a communication network 20. The content server 80 may be the supply source of the contents data CD with respect to the AV receiver 10. In this case, as shown in FIG. 6, a reception unit 160 may execute a process of providing the contents data CD received via the communication network 20 to an input processing unit 110. That is to say, the reception unit 160 may have a role of acquiring the contents data.

### Third Modified Example

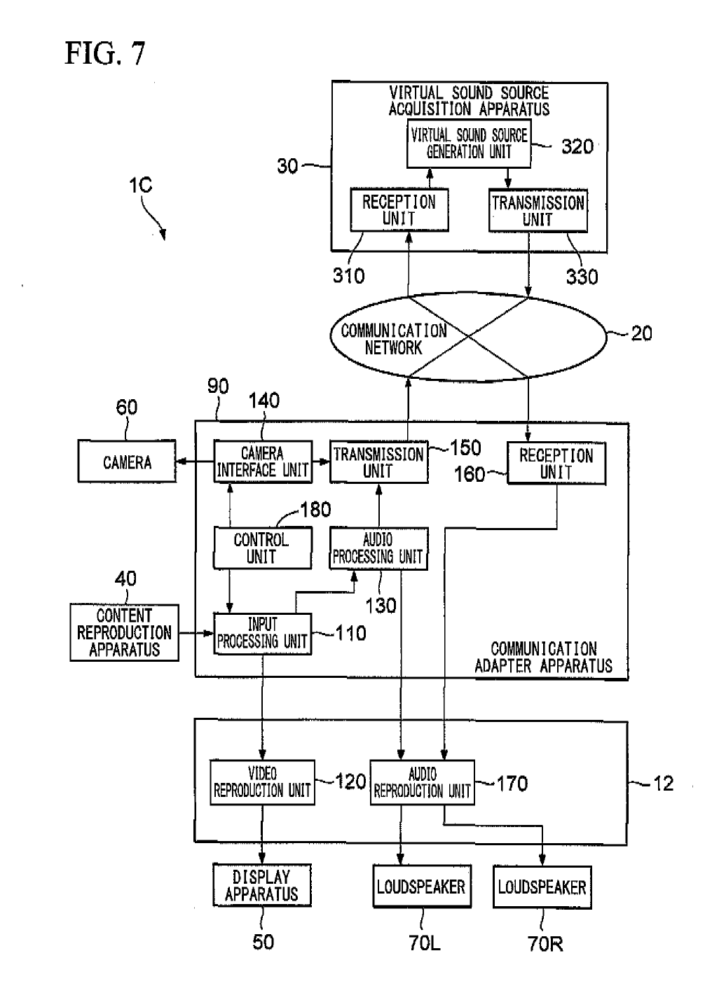

FIG. 7 shows a communication system 1C according to a third modified example.

The communication system 1C includes at least an AV amplifier 12, a content reproduction apparatus 40, a camera 60, and a communication adapter apparatus 90. As shown in FIG. 7, the communication adapter apparatus 90 includes an input processing unit 110, an audio processing unit 130, a camera interface unit 140, a transmission unit 150, a reception unit 160, and a control unit 180. The communication adapter apparatus 90 is connected to a content reproduction apparatus 40, a camera 60, and a communication network 20. Moreover, the communication adapter apparatus 90 is connected to the AV amplifier 12. The AV amplifier 12 is connected to the communication network 20 via the communication adapter apparatus 90. According to the configuration, even if an AV amplifier 12 only having a video reproduction unit 120 and an audio reproduction unit 170 is used, the same effect as that of the first embodiment and the second embodiment can be acquired. The communication adapter apparatus 90 may be a specific example of the communication apparatus.

### Fourth Modified Example

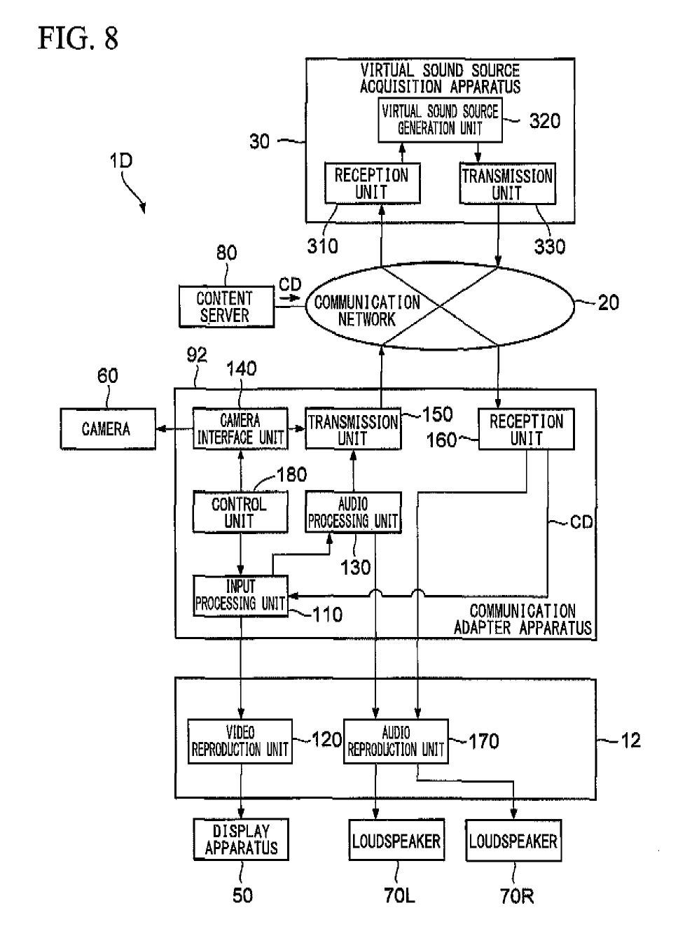

FIG. 8 shows a communication system 1D according to a fourth modified example. As shown in FIG. 8, the communication system 1D includes a communication adapter apparatus 92 instead of the communication adapter apparatus 90 shown in FIG. 7. The communication adapter apparatus 92 is connected to the AV amplifier 12 to acquire the contents data CD from the content server 80 via the communication network 20. The communication adapter apparatus 92 may be a specific example of the communication apparatus.

### Fifth Modified Example

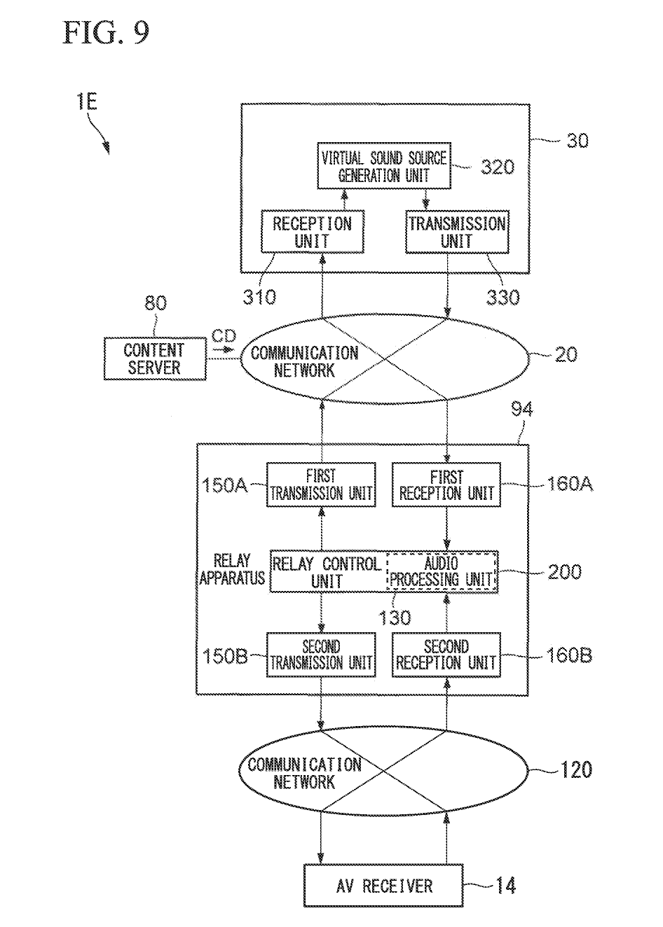

FIG. 9 shows a communication system 1E according to a fifth modified example. The communication system 1E includes an AV receiver 14, a conversion apparatus 30, a content server 80, and a relay apparatus 94. The relay apparatus 94 mediates data communication performed with the content server 80, according to a predetermined communication protocol. Specifically, the relay apparatus 94 mediates communication between the AV receiver 14 and the content server 80. As shown in FIG. 9, the relay apparatus 94 is connected to a communication network 20. The communication network 20 is connected to the content server 80 and the conversion apparatus 30. The relay apparatus 94 includes a first transmission unit 150A, a first reception unit 160A, a second transmission unit 150B, a second reception unit 160B, and a relay control unit 200. The first transmission unit 150A and the first reception unit 160A are connected to the communication network 20. The second transmission unit 150B and the second reception unit 160B are connected to a communication network 120 connected to the AV receiver 14. The first transmission unit 150A is provided with data from the relay control unit 200, and sends the data to the communication network 20. The second transmission unit 150B is provided with data from the relay control unit 200, and sends the data to the communication network 120. The first reception unit 160A provides the data received from the communication network 20 to the relay control unit 200. The second reception unit 160B provides the data received from the communication network 120 to the relay control unit 200.

The relay control unit 200 receives a content download request received from the AV receiver 14 via the second reception unit 160B (a content download request transmitted to the content server 80), and provides the content download request to the first transmission unit 150A, to transfer it to the content server 80. The relay control unit 200 receives image data from the AV receiver 14, and provides the image data to the first transmission unit 150A to transfer the image data to the conversion apparatus 30. The content server 80 receives the content download request transferred by the relay apparatus 94 in this way. The content server 80 transmits content, for which download is requested by the content download request, to the AV receiver 14 via the relay apparatus 94 and the communication network 120. The conversion apparatus 30 receives the image data transferred by the relay apparatus 94. The conversion apparatus 30 analyzes the image data to generate head shape data representing the head shape of the viewer, and stores the head shape data in association with an identifier indicating a transmission source of the image data.

The relay control unit 200 includes the audio processing unit 130 described above. The relay control unit 200 receives the contents data from the content server 80 via the first reception unit 160A. The relay control unit 200 provides audio data included in the contents data to the audio processing unit 130. The relay control unit 200 causes the audio processing unit 130 to discriminate whether the audio data is two-channel audio data or multichannel audio data. When it is discriminated that it is two-channel audio data, the relay control unit 200 provides the received contents data to the second transmission unit 150B, to transfer it to the destination thereof (that is, the AV receiver 14 being the transmission source of the content download request). When it is discriminated that it is multichannel audio data, the relay control unit 200 adds a communication address of the AV receiver 14 as the identifier indicating the transmission source to the multichannel audio data, and transmits it to the conversion apparatus 30. The relay control unit 200 receives the two-channel audio data transmitted from the conversion apparatus 30 to the AV receiver 14, via the first reception unit 160A. The relay control unit 200 replaces the multichannel audio data included in the contents data with the two-channel audio data, and transfers the contents data to the AV receiver 14. The same effect as that of the first and second embodiments can be acquired according to the fifth modified example.

### Sixth Modified Example

Upon reception of the multichannel audio data from a plurality of AV receivers (transmission sources) 10, the conversion apparatus 30 according to the first and second embodiments converts the multichannel audio data into the two-channel audio data in the order of reception. However, the configuration is not limited thereto. The conversion apparatus 30 may perform so-called QoS (Quality of Service). Specifically, the conversion apparatus 30 prioritizes the transmission sources of the multichannel audio data in advance.

As a specific example, in a situation in which the priority of the first transmission source is set higher than the priority of the second transmission source, a case in which the reception unit 330 acquires first multichannel audio data associated with the first transmission source and second multichannel audio data associated with the second transmission source will be described. In this case, a computing unit 321 compares the priority of the first transmission source and the priority of the second transmission source to determine that the priority of the first transmission source is higher. Consequently, the computing unit 321 starts conversion of the first multichannel audio data into the virtual sound source first. While converting the first multichannel audio data into the virtual sound source, the computing unit 321 stores the multichannel audio data received from the second transmission source in a storage unit (queue) 322. The computing unit 321 does not start conversion of the multichannel audio data of the second transmission source into the virtual sound source, until the computing unit 321 finishes conversion of the multichannel audio data received from the first transmission source into the virtual sound source, and the transmission unit 330 transmits the multichannel audio data converted into the virtual sound source.

As another specific example, in a situation in which the priority of the first transmission source is set higher than the priority of the second transmission source, a case in which the reception unit 320 receives the first multichannel audio data from the first transmission source while the computing unit 321 is converting the second multichannel audio data received from the second transmission source into the virtual sound source will be described. In this case, the computing unit 321 stops conversion of the second multichannel audio data into the virtual sound source, and starts conversion of the first multichannel audio data into the virtual sound source. In this case, the computing unit 321 restarts conversion of the second multichannel audio data into the virtual sound source after conversion of the first multichannel audio data into the virtual sound is complete.

The conversion apparatus 30 may execute QoS according to the content of the received multichannel audio data, not according to the priority of the transmission source. For example, the conversion apparatus 30 prioritizes the process of the multichannel audio data representing music (such as musical performance sound of a musical composition or singing voice) more than the process of the multichannel audio data representing voice such as conversation. The reason why such a process is performed is that generally, even if voice in conversation is intermittently reproduced, there is no large influence; however, in the case of music, the influence of intermittent reproduction is great.

As a specific example, in a situation in which the priority of a first content (music) is set higher than a second content (voice), a case in which the reception unit 330 acquires the first multichannel audio data associated with the first content and the second multichannel audio data associated with the second content will be described. In this case, the computing unit 321 compares the priority of the first content and the priority of the second content to determine that the priority of the first content is higher. Consequently, the computing unit 321 prioritizes conversion of the first multichannel audio data into the virtual sound source.

A case in which QoS is executed by the relay apparatus 94 shown in FIG. 9 will be described. In this case, the audio processing unit 130 controls the order of processing of a plurality of pieces of audio data according to the priority of the destination of the contents data.

### INDUSTRIAL APPLICABILITY

The present invention may be applied to a communication method, a sound apparatus, and a communication apparatus.

### REFERENCE SYMBOLS

1A, 1B, 1C, 1D, 1E Communication system
10 AV receiver
12 AV amplifier
110 Input processing unit
120 Video reproduction unit
130 Audio processing unit
140 Camera interface unit
150 Transmission unit
160 Reception unit
170 Audio reproduction unit
180 Control unit
20 Communication network
30 Conversion apparatus
310 Reception unit
320 Virtual sound source generation unit
330 Transmission unit
80 Content server
90, 92 Communication adapter apparatus
94 Relay apparatus
150A First transmission unit
160A First reception unit
150B Second transmission unit
160B Second reception unit
200 Relay control unit

1. A communication method for a communication system, the communication system including: a sound apparatus connected with two loudspeakers and connected to a communication network; and a conversion apparatus connected to the communication network, the communication method comprising:
acquiring multichannel audio data including pieces of audio data of a left front channel, a right front channel, and a first channel;
transmitting the multichannel audio data from the sound apparatus to the conversion apparatus via the communication network;
converting audio data of at least the first channel of the multichannel audio data into a virtual sound source by using a head-related transfer function;
superimposing the converted audio data of at least the first channel on the left front channel and the right front channel to generate two-channel audio data;
transmitting the two-channel audio data from the conversion apparatus to the sound apparatus via the communication network; and
driving the two loudspeakers according to the two-channel audio data.

2. The communication method according to claim 1, further comprising:
acquiring image data representing a head of a user;
transmitting the image data from the sound apparatus to the conversion apparatus; and
analyzing the image data to detect a head shape of the user,
wherein the converting into the virtual sound source includes converting the audio data of the first channel into a virtual sound source by using a head-related transfer function according to the head shape of the user.

3. The communication method according to claim 2, further comprising:
analyzing the image data to detect a direction of a face of the user; and
calculating the head-related transfer function with taking into account the direction of the face of the user.

4. The communication method according to claim 1, comprising:
transmitting image data representing a head of a user from the sound apparatus to the conversion apparatus at every predetermined time; and
analyzing the image data every time the image data is received in the conversion apparatus to detect a head shape of the user,
wherein the converting into the virtual sound source includes converting the audio data of the first channel into a virtual sound source by using a head-related transfer function according to the head shape of the user.

5. The communication method according to claim 1, further comprising:
acquiring second image data representing a head of a user after acquiring first image data representing the head of the user;
transmitting the first image data from the sound apparatus to the conversion apparatus;
determining whether the second image data is different from the first image data;
transmitting the second image data from the sound apparatus to the conversion apparatus in response to a determination that the second image data is different from the first image data; and
analyzing the second image data to detect a head shape of the user,
wherein the converting into the virtual sound source includes converting the audio data of the first channel into a virtual sound source by using a head-related transfer function according to the head shape of the user.

6. The communication method according to claim 1,
wherein the multichannel audio data is first multichannel audio data associated with a first transmission source, and
the communication method further comprises:
acquiring second multichannel audio data associated with a second transmission source having a higher priority than the first transmission source;
determining which of the first transmission source and the second transmission source has a higher priority; and
prioritizing conversion into a virtual sound source of the second multichannel audio data associated with the second transmission source determined to have a higher priority, over that of the first multichannel audio data.

7. The communication method according to claim 1,
wherein the multichannel audio data is first multichannel audio data representing a first content, and
the communication method further comprises:
acquiring second multichannel audio data representing a second content having a higher priority than the first content;
determining which of the first content and the second content has a higher priority; and
prioritizing conversion into the virtual sound source of the second multichannel audio data representing the second content determined to have a higher priority, over that of the first multichannel audio data.

8. A sound apparatus comprising:
an acquisition unit that acquires multichannel audio data;
a transmission unit that transmits the multichannel audio data to a conversion apparatus via a communication network;
a reception unit that receives from the conversion apparatus, two-channel audio data generated by converting the multichannel audio data into a virtual sound source by the conversion apparatus; and
an audio reproduction unit that drives two loudspeakers according to the two-channel audio data.

9. A communication apparatus comprising:
an acquisition unit that acquires multichannel audio data;
a transmission unit that transmits the multichannel audio data to a conversion apparatus via a communication network;
a reception unit that receives from the conversion apparatus via the communication network, two-channel audio data generated by converting the multichannel audio data into a virtual sound source by the conversion apparatus; and
an output unit that outputs the two-channel audio data to a sound apparatus.
